(19) United States
(12) Patent Application Publication
(10) Pub. No.: US 2026/0054606 A1
(43) Pub. Date: Feb. 26, 2026

(54) HEATED BRACKET ASSEMBLY FOR SUPPORTING POWER RAILS

(71) Applicant: Caterpillar Inc., Peoria, IL (US)

(72) Inventors: Igor Strashny, Tucson, AZ (US); Roopa Rajesh, Tucson, AZ (US)

(73) Assignee: Caterpillar Inc., Peoria, IL (US)

(21) Appl. No.: 18/811,010

(22) Filed: Aug. 21, 2024

(51) Int. Cl. B60M 1/30; B60M 1/02

(52) U.S. Cl. CPC B60M 1/307; B60M 1/02

(57) ABSTRACT

A power rail retention system includes a heated bracket assembly for supporting conducting power rails. Power rails carrying different voltages supplied by a substation rest on a support plate that includes grooves configured to accept lower sections of angled clips. Upper sections of the clips frictionally hold the power rails against the support plate. A resistor is coupled between the lower sections of at least two conductive clips and is positioned proximate a top edge of the support plate between adjacent rails. When the rails are energized, current flows through the resistor, which may generate ambient heat to evaporate moisture on the support plate, power a light source on the bracket, and provide a ballast load for the substation.

### TECHNICAL FIELD

The present disclosure relates generally to a system and method for supplying electrical power to a mobile machine, and more specifically, to a heated bracket assembly supporting the power rails that supply the electrical power to the mobile machine.

### BACKGROUND

Heavy work machines, such as earth-moving vehicles or hauling trucks, require significant power to carry out their functions. The machines themselves can be of substantial weight, and their loads require large amounts of power to move. Diesel engines traditionally provide that power, but they can have disadvantages. For instance, supplies of diesel fuel may be far away from a haul route or work location, and diesel machines can generate substantial pollution.

Electrically powered machines can provide many advantages over diesel machines, but also pose some challenges. The electric engine and components in the work machine require significant electrical power at different voltage levels. Power, or conductor, rails positioned on the ground may provide the voltages to vehicles that travel on a fixed track, such as trains or subways. For a heavy work machine that is freely steerable, however, establishing and maintaining an electrical connection with a ground rail can be challenging. Moreover, power rails on the ground, as with trains and subways, can pose safety risks to personnel and be subjected to debris from the travel path in dirty environments such as a mine site.

Elevated power rails can avoid disturbances and risks from the ground. A stanchion formed from posts with an insulative support structure at the top can provide a secure platform for spans of power rails and may be rapidly deployed and decommissioned within a work site as needs evolve. However, due to the high voltages between the rails, which may reach 3,000 volts DC in some situations, current leakage through several of the insulative support structures can decrease the voltage deliverable to the work machine. While the support structure can be shaped to provide sufficient clearance between rails and to increase creepage, moisture accumulated on the support structures can lessen the dielectric resistance and lead to an increase in current leakage.

One approach for providing electrical power to a work machine while traveling on a roadway is described in International Patent App. Pub. No. WO 2020/186296A1 (“the '296 publication”). The '296 publication describes an electrical delivery system at a mine site for a moving vehicle where two or more conductors are anchored to relocatable barriers on the ground. In one embodiment in the '296 publication, the conductors are slightly elevated above the roadway and mounted on opposing surfaces of a vertically extending wall and covered with a shroud. Insulating mounts and an air gap help isolate the conductors electrically, and beveled sides of the wall break water flow along them into droplets to improve isolation properties. However, the '296 publication does not contemplate creepage or current leakage between conductor rails resting on an insulative support structure. Nor does the '296 publication address the potential impact on dielectric resistance and current leakage from moisture accumulation on the support structure. As a result, the delivery system of the '296 publication does not provide a desirable approach to avoiding potential voltage drop along power rails caused by current leakage within an insulative support structure.

Examples of the present disclosure are directed to overcoming deficiencies of such systems.

### SUMMARY

In an aspect of the present disclosure, a bracket assembly for retaining power rails includes an insulative base having at least a top surface with a first rail support portion configured to receive a first of the power rails and a second rail support portion configured to receive a second of the power rails. The bracket assembly includes a first conductive clip proximate the first rail support portion, a second conductive clip proximate the second rail support portion, and a resistor electrically connected to the first conductive clip and the second conductive clip. The resistor is positioned proximate to the top surface of the insulative base and configured to emit heat to the top surface when current from the power rails passes through the resistor.

In another aspect of the present disclosure, a power rail retention system includes an inner power rail having a first flanged bottom, an outer power rail having a second flanged bottom, a support pole having a top end and a bottom end, and a bracket assembly attached adjacent to the top end of the support pole. The bracket assembly includes a support plate having at least a top edge with an inner rail portion configured to support the inner power rail and an outer rail portion configured to support the outer power rail. The bracket assembly further includes a resistor electrically coupled to the inner power rail and to the outer power rail, where the resistor is positioned adjacent the top edge of the support plate.

In yet another aspect of the present disclosure, a method for assembling a power rail retention system includes placing an inner power rail on an inner rail portion on a top edge of a support plate, installing a lower section of an inner conductive clip into an inner groove within the support plate, and contacting an upper section of the inner conductive clip to the inner power rail. The method further includes placing an outer power rail on an outer rail portion on the top edge of the support plate, installing a lower section of an outer conductive clip into an outer groove within the support plate, and contacting an upper section of the outer conductive clip to the outer power rail. An inner end of a resistor is connected to the lower section of the inner conductive clip and an outer end of the resistor is connected to the lower section of the outer conductive clip. Finally, the resistor is positioned adjacent a top edge of the support plate.

### BRIEF DESCRIPTION OF DRAWINGS

The detailed description references the accompanying figures. In the figures, the left-most digit of a reference number identifies the figure in which the reference number first appears. The same reference numbers indicate similar or identical items.

FIG. 1 is a schematic illustration of an electrically powered work machine coupled to a roadside power source in accordance with an example of the present disclosure.

FIG. 2 is a rear view of a support structure for holding power rails in an elevated position in accordance with an example of the present disclosure.

FIG. 3A is a rear view of a power rail retention system in accordance with an example of the present disclosure.

FIG. 3B is an isometric view of the power rail retention system in accordance with an example of the present disclosure.

FIG. 4 is front view and rear view of an inner conductive clip in FIGS. 3A and 3B in accordance with an example of the present disclosure.

FIG. 5 is a front view of a heated bracket assembly of the power rail retention system of FIGS. 3A and 3B in accordance with an example of the present disclosure.

FIG. 6A is a top view of a heated bracket assembly for a right-handed machine in accordance with an example of the present disclosure.

FIG. 6B is a top view of a heated bracket assembly for a left-handed machine in accordance with an example of the present disclosure.

FIG. 7A is an isometric front view of clips for the heated bracket assembly in FIG. 6A in accordance with an example of the present disclosure.

FIG. 7B is an isometric front view of clips for the heated bracket assembly in FIG. 6B in accordance with an example of the present disclosure.

FIG. 8 is a flow chart depicting a method for assembling a power rail retention system with a heated bracket assembly in accordance with an example of the present disclosure.

### DETAILED DESCRIPTION

Consistent with the principles of the present disclosure, a power rail retention system includes a heated bracket assembly for supporting conducting power rails. The power rails carry different voltages supplied by a substation and rest on a support plate that may include grooves configured to accept lower sections of clips. Upper sections of the clips frictionally hold the power rails against the support plate. A resistor is coupled between the lower sections of at least two conductive clips and is positioned proximate a top edge of the support plate between adjacent rails. When the rails are energized, current flows through the resistor, which generates ambient heat to evaporate moisture on the support plate. The current may also power a light source on the bracket for safety and guidance of a work machine moving aside the rails. Further, current passing between the rails and through the resistor may provide a ballast for the substation when no other load is on the energized rails. The following describes several examples for carrying out the principles of this disclosure.

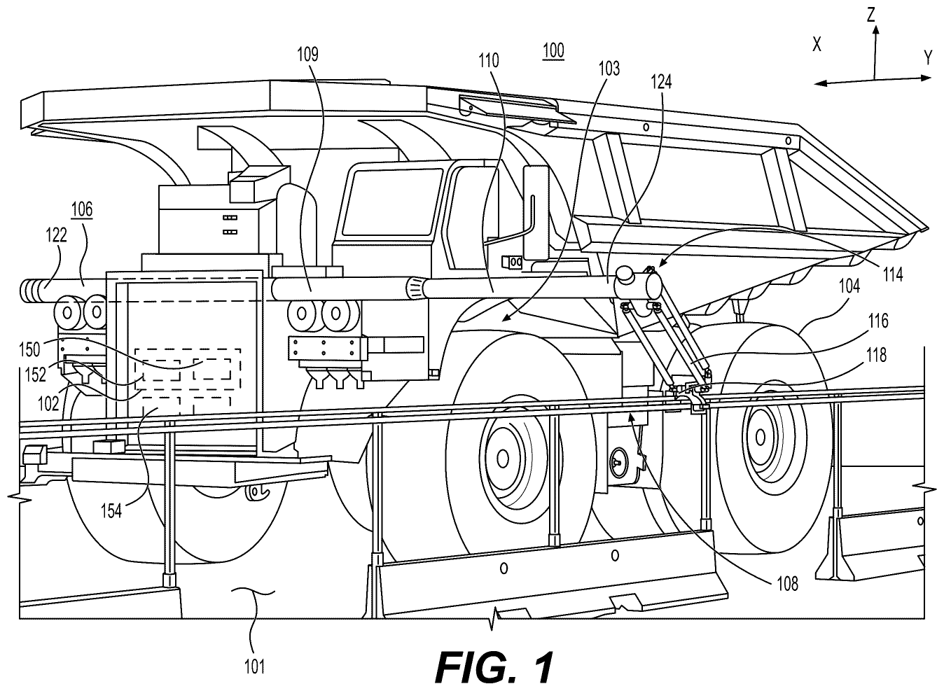

FIG. 1 illustrates an isometric view of a work machine 100 within an XYZ coordinate system as one example suitable for containing the power rail retention system of this disclosure. Exemplary work machine 100 travels parallel to the X axis along a roadway, also termed a haul route 101, typically from a source to a destination within a worksite. In one implementation as illustrated, work machine 100 is a hauling machine that hauls a load within or from a worksite within a mining operation. For instance, work machine 100 may haul excavated ore or other earthen materials from an excavation area along haul route 101 to dump sites and then return to the excavation area. In this arrangement, work machine 100 may be one of many similar machines configured to ferry earthen material in a trolley arrangement. While a large mining truck in this instance, work machine 100 may be any machine that carries a load between different locations within a worksite, examples of which include an articulated truck, an off-highway truck, an on-highway dump truck, a wheel tractor scraper, or any other similar machine. Alternatively, work machine 100 may be an off-highway truck, on-highway truck, a dump truck, an articulated truck, a loader, an excavator, a pipe layer, or a motor grader. In other implementations, work machine 100 need not haul a load and may be any machine associated with various industrial applications including, but not limited to, mining, agriculture, forestry, construction, and other industrial applications.

Referring to FIG. 1, and relevant to the present disclosure, an example work machine 100 includes a frame 103 powered by electric engine 102 to cause rotation of traction devices 104. Traction devices 104 are typically four or more wheels with tires, although tracks or other mechanisms for engagement with the ground along haul route 101 are possible. Electric engine 102 provides mechanical energy to work machine 100 based on electrical power sources, such as described in further detail below. An example of mechanical energy provided by electric engine 102 includes propelling traction devices 104 to cause movement of work machine 100 along haul route 101, but electric engine 102 also includes components sufficient to power other affiliated operations within work machine 100. For instance, in some implementations, electric engine 102 includes equipment for converting electrical energy to provide pneumatic or hydraulic actions within work machine 100. While electric engine 102 is configured to operate from an external electrical power source, electric engine 102 typically includes one or more batteries for storing electrical energy for auxiliary or backup operations, as discussed in more detail below.

Electric engine 102 includes one or more motors 150 responsible for generating torque to propel work machine 100. Motors 150 when operating together are configured to propel the work machine 100 as needed for tasks that are to be performed by the work machine 100. For example, the motors 150 may be rated for a range of about 500 volts to about 3000 volts. A motor controller 152 includes control electronics configured to control the operation of motors 150. According to examples of the disclosure, electrical power to energize motors 150 is received from a battery module 154. Battery module 154 may provide power for operating motors 150 and/or other power consuming components (e.g., controllers, cooling systems, displays, actuators, sensors, etc.) of work machine 100, as well as for propelling work machine 100 in certain situations. The presently disclosed subject matter is not limited solely to the use of battery power, as other forms of energy may be used in conjunction with the power provided by the battery module 154, including, but not limited to, internal combustion engines or fuel cells, and external electrical sources discussed further below.

In addition to, or alternative to, obtaining electrical energy from battery module 154, electric engine 102 may obtain electrical energy from an external source. For example, work machine 100 further includes a conductor rod 106 configured to receive electrical power from two or more power rails 108. In some examples, power rails 108 are two or more beams of metal arranged substantially parallel to and a distance above the ground. In FIG. 1, power rails 108 are positioned to be substantially parallel to the X axis and the direction of travel of work machine 100. Support mechanisms hold power rails 108 in place along a distance at the side of haul route 101 for work machine 100 to traverse. While shown in FIG. 1 to the left of work machine 100 as work machine 100 travels in the direction of the X axis, power rails 108 may be installed to the right of work machine 100 or in other locations suitable to the implementation.

Power rails 108 provide a source of electrical power for work machine 100 as either AC or DC. In some examples, power rails 108 have two or more conductors, each providing voltage and current at a different electrical pole. In one implementation (e.g., an implementation in which the power rails 108 include three conductors), one conductor provides positive DC voltage, a second conductor provides negative DC voltage, and a third conductor provides 0 volts relative to the other two conductors. The two powered conductors within power rails 108 can provide a variety of voltage levels, such as a voltage difference greater than 2500 volts, which may be delivered as +1500 VDC and 1500 VDC in one example. These values are exemplary, and other physical and electrical configurations for power rails 108 are available and within the knowledge of those of ordinary skill in the art.

Conductor rod 106 enables electrical connection between work machine 100 and power rails 108, including during movement of work machine 100 along haul route 101. In the example shown in FIG. 1, conductor rod 106 is an elongated arm resembling a pole. FIG. 1 shows conductor rod 106 positioned along a front side of work machine 100, with respect to the direction of travel of work machine 100 in the direction of the X axis. As embodied in FIG. 1, conductor rod 106 includes a barrel 109 mounted to frame 103 of work machine 100. Barrel 109 has a hollow interior and may be a conductive metal having suitable mechanical strength and resiliency, such as aluminum. Within, and possibly including barrel 109, conductor rod 106 includes a series of electrical conductors passing longitudinally, at least from a head 122 at a proximal end to a tip 124 at a distal end. Tubular conductors within arm 110 slidably engage with corresponding tubular conductors within barrel 109 to maintain electrical continuity as arm 110 is extended or retracted. In other examples, conductor rod 106 may comprise a boom with a trailing or folding arm that is selectively movable with respect to frame 103 between a retracted position and an extended position. The boom may be pivotably connected to frame 103, while the trailing arm may be capable of being contracted or folded in a storage configuration when not in use.

At a position away from the work machine at tip 124, a connector assembly 114 provides an interface to power rails 108 via trailing arms 116 and contactor 118. Power rails 108 are typically arranged along a side of haul route 101, and work machine 100 is steered so that it traverses haul route 101 substantially in parallel with power rails 108. Contactor 118 may include multiple degrees of freedom to allow contactor 118 to align and ride on top of power rails 108. In operation, electrical power is accessed from power rails 108 via contactor 118, and the electrical power is conducted through trailing arms 116 into connector assembly 114 and to work machine 100 for powering electric engine 102 and otherwise enabling operations within work machine 100.

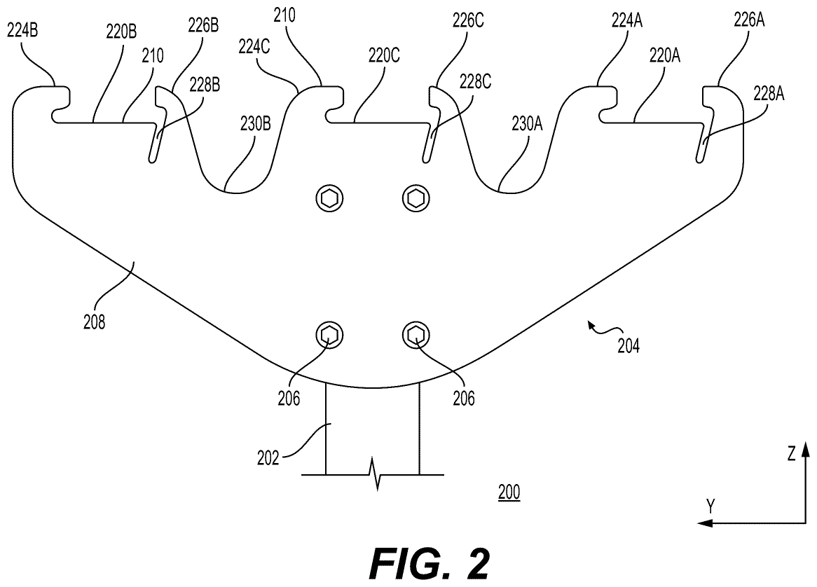

While FIG. 1 illustrates a general example of an electric work machine 100, FIG. 2 is a front view of a support structure 200 that includes a support pole 202 and a support plate 204 for holding power rails 108 in an elevated position to provide electrical power. The support pole 202 is a rod, pole, post, cylinder, or similar structure having a length for elevating and supporting power rails 108 above ground. In some examples, support pole 202 is made of pultruded fiberglass-reinforced plastic (FRP), or similar dielectric or electrically insulative materials. In other examples, support pole 202 is made of a conductive material, such as steel, which may be galvanized for corrosion resistance. With a conductive material, support pole 202 may additionally provide an electrical path from one of power rails 108 to ground where the pole is secured (not shown). Support pole 202 has a length sufficient to stabilize power rails 108 at an elevated position, such as about eight feet off the ground. Support plate 204 is a flat structure that may be made of pultruded FRP or other dielectric materials and is configured to support two or more of power rails 108 elevated above ground by support pole 202. Support plate 204 may be attached to support pole 202 by way of one or more fasteners 206.

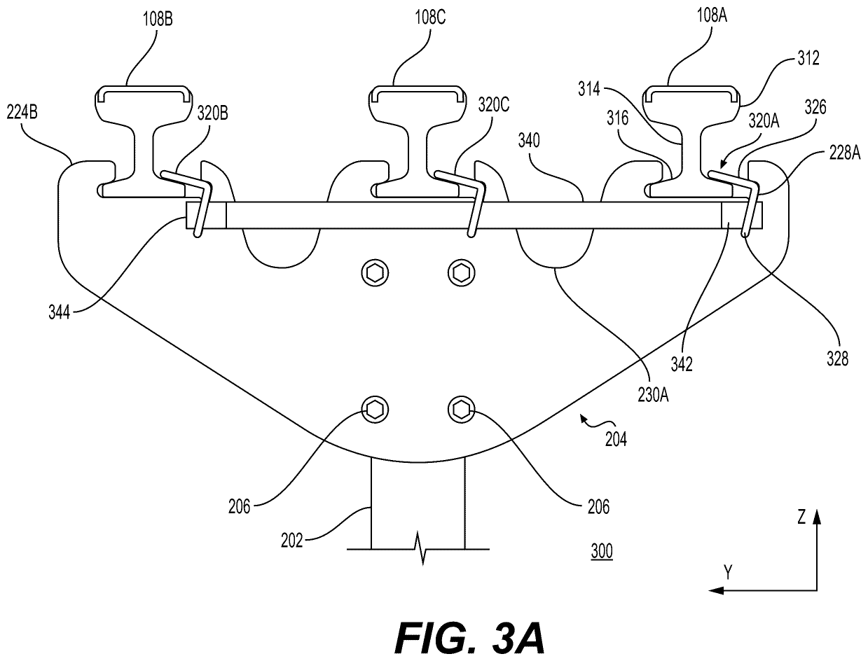

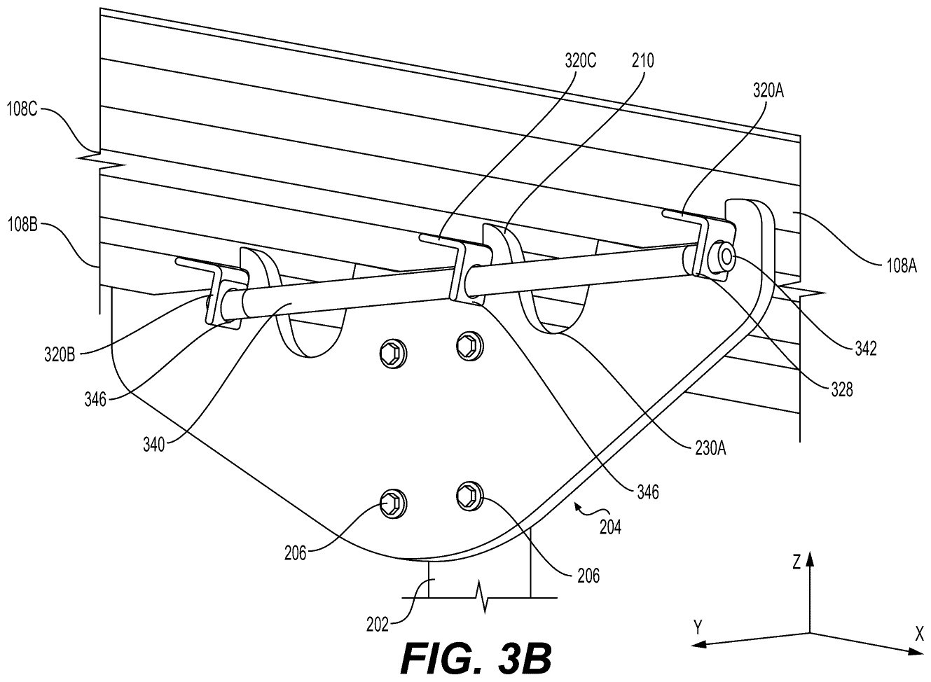

In the example illustrated, a rear face 208 of support plate 204 is typically a flat or planar surface with the lower portion of support plate 204 generally having a curved or angled profile. A top edge 210 of support plate 204 includes several slots or indentations for accommodating two or more of the power rails 108. In one example, top edge 210 of support plate 204 includes inner rail support 220A, outer rail support 220B, and middle rail support 220C, as horizontal surfaces for holding one of three power rails, respectively (FIG. 3). Additionally, top edge 210 may be shaped to form teeth 224, specifically, inner tooth 224A, outer tooth 224B, and middle tooth 224C that can receive and hold a lower flange of a respective power rail. At an opposite side of rail supports 220 from teeth 224, walls 226 rise above the rail supports 220. The walls 226 include grooves 228 within support plate 204 that may receive structures for holding and retaining power rails 108 in a manner discussed further below. Between adjacent rail supports 220, concavities 230 are formed, such as first concavity 230A between inner tooth 224A and middle wall 226C and second concavity 230B between middle tooth 224C and outer wall 226B. While shown as substantially circular recesses, first concavity 230A and second concavity 230B may have a depth, curvature, and overall shape based on the implementation for increasing creepage distance.

FIGS. 3A and 3B illustrate support structure 200 implemented within a power rail retention system 300 for providing electrical power to sliding contactors such as those within a work machine 100 similar to FIG. 1. In FIGS. 3A and 3B, the power rails 108 of FIG. 1 are depicted as having three rails, inner power rail 108A, outer power rail 108B, and middle power rail 108C. It will be appreciated that power rail retention system 300 may be implemented with a different number of power rails 108, such as only inner power rail 108A and outer power rail 108B. Referring to inner power rail 108A as an example, the power rails 108 have a profile resembling a modified I-beam and include a flanged top 312, a rail web 314, and a flanged bottom 316. The power rails 108 may be made of any suitable conductive material, and in some examples are aluminum with an upper plate of stainless steel.

The power rails 108 are positioned within the rail supports 220, such that inner power rail 108A rests within inner rail support 220A, outer power rail 108B rests within outer rail support 220B, and middle power rail 108C rests within middle rail support 220C. In this configuration, flanged top 312 of each rail is exposed vertically above top edge 210, which enables unobstructed engagement by contactor 118 with power rails 108 without excess maneuvering by conductor rod 106 on work machine 100. As shown in FIG. 3A, the flanged bottoms 316 are positioned on rail supports 220 between teeth 224 and walls 226. For example, one side of flanged bottom 316 is lodged under one of the teeth 224 of support plate 204, such as flanged bottom 316 of inner power rail 108A being placed under inner tooth 224A. Opposite to the teeth 224, walls 226 include grooves 228 that help support clips 320. The grooves 228 extend below the surface of the rail supports 220 and at an acute angle with respect to the rail supports 220.

Clips 320 function to frictionally lock power rails 108 to support plate 204 and may take any shape to accomplish that function. In some examples, clips 320 have an upper section 326 and a lower section 328. The two sections of clips 320 may be angular, curved, or linear with respect to each other. In the examples illustrated, the two sections of the clips form an angle, typically acute or approximating 90 degrees, where a shape of the clips resembles an angle bracket. The angle creates a resilient springing action between upper section 326 and lower section 328 if those sections are stretched or pulled away from each other. Lower section 328 may be inserted into one of grooves 228 along the side of a respective one of the rail supports 220. The upper section 326 of the clip then presses against a flanged bottom 316 of one of the power rails to frictionally lock that power rail in place. In some examples, the frictional locking of power rails 108 with clips 320 permits some pliability to the attachment of the power rails 108 to support plate 204 to accommodate small movements that may occur with either the power rails 108 or support plate 204. While depicted as angles in the figures, other shapes and forms for the clips are within the scope of the present disclosure and may be adopted based on the implementation.

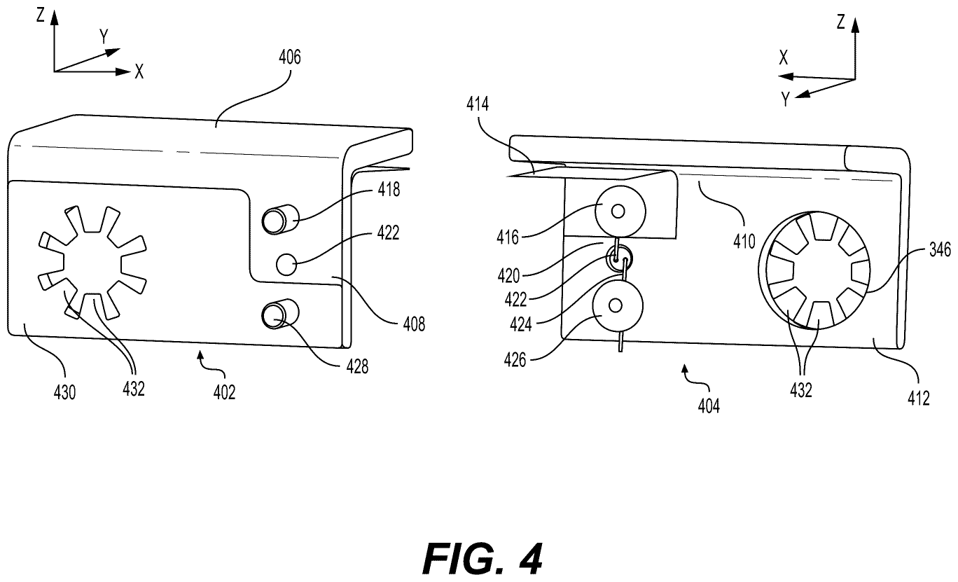

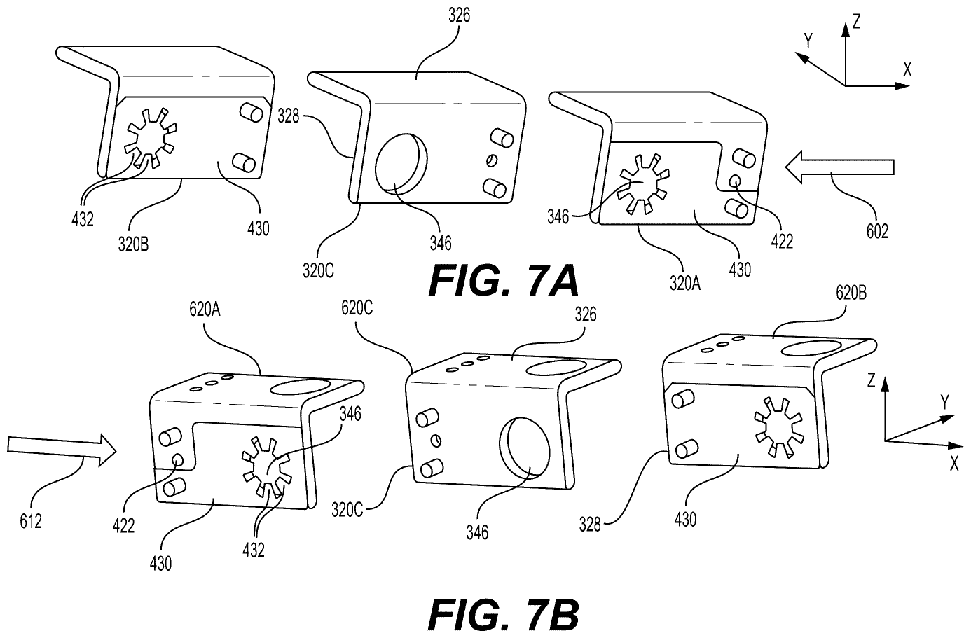

In some examples, the clips 320 are formed from a base or frame of insulative material, such as pultruded FRP. Depending on their positioning and function, the clips may include other materials, such as a coating or outer layer of conductive material, to provide conductivity in a manner and for purposes discussed below with respect to FIGS. 4, 7A, and 7B. The clips may differ in their structure based, at least in part, on their required functions, such as to provide a particular electrical path or operation. In other examples, clips that are desired to be conductive may be constructed on a base or frame of conductive material, such as spring steel or similar material.

In addition to being shaped to retain power rails and attachment clips, support plate 204 may be shaped to account for electrical issues arising from the voltage differences between the rails. In one example, those voltage differences result from +1500VDC on inner power rail 108A, −1500VDC on outer power rail 108B, and 0 VDC on middle power rail 108C. For instance, to ensure sufficient electrical clearance, the rail supports 220 are separated across top edge 210 in excess of relevant rail-to-rail clearance criteria. In one example, a center-to-center distance between adjacent rail supports 220, such as between inner rail support 220A and middle rail support 220C, is 200 mm. Additionally, first concavity 230A and second concavity 230B may be selected by the skilled artisan to increase creepage between power rails 108. By being curved, first concavity 230A and second concavity 230B increase the dielectric distance through support plate 204 between adjacent rail segments. The depth, curvature, and overall shape of first concavity 230A and second concavity 230B may be selected by the skilled artisan to accomplish the objectives of increasing creepage beyond criteria for the rails while maintaining mechanical resiliency to support plate 204.

Current leakage through support plate 204 and dielectric breakdown may threaten to detract from the electrical performance of a power rail retention system. Moisture on support plate 204 from precipitation or condensation can decrease dielectric resistance and exacerbate current leakage at rail supports 220. Moreover, a rail system along a haul route may include dozens or hundreds of rail supports, compounding the potential loss. While the planar shape of support plate 204 and relatively narrow width of top edge 210 in some examples can help shed excess moisture and avoid accumulation, moisture along top edge 210 could lead to increased current leakage and a decrease in operating voltage for power rails 108. As discussed below, power rail retention system 300 includes a source of heat proximate to top edge 210 to help melt and evaporate moisture on support plate 204 near rail supports 220.

FIGS. 3A and 3B illustrate a heat source in the form of resistor 340 electrically coupled between at least inner conductive clip 320A and outer conductive clip 320B of power rails 108. Due to the electrical conductivity of inner conductive clip 320A and outer conductive clip 320B and their contact with inner power rail 108A and outer power rail 108B, respectively, the electrical coupling of resistor 340 to inner conductive clip 320A and outer conductive clip 320B forms an electrical circuit through these components. A resistance for resistor 340 may be chosen based on the voltage drop between the rails to which it is connected (e.g., inner power rail 108A and outer power rail 108B) to generate a desired quantity of heat energy when the power rails are energized. In some examples, generation of 80-120 Watts of heat energy should be sufficient to melt accumulated snow and evaporate moisture. In one example, resistor 340 has a resistance of about 75 k Ohms. With a voltage drop between inner conductive clip 320A and outer conductive clip 320B of 3000VDC, about 40 mA will flow through resistor 340. In another example, resistor 340 may be electrically connected between two adjacent rails, such as inner power rail 108A and middle power rail 108C, and chosen to have an appropriate resistance for the voltage drop to radiate heat to the support plate 204. In either configuration for resistor 340 and in others, the generated heat energy will radiate in a region around resistor 340 and help increase the temperature on support plate 204 near top edge 210 and in the surrounding atmosphere. Accordingly, moisture collecting on top edge 210 will be evaporated, which will help avoid deleterious effects from current leakage through support plate 204 or dielectric breakdown of support plate 204.

In one example, resistor 340 may be a cylindrical or rod-shaped ceramic resistor having an inner end 342 and an outer end 344. In this option, as shown in FIGS. 3A and 3B, resistor 340 has a length between inner end 342 and outer end 344 that exceeds the distance between inner conductive clip 320A and outer conductive clip 320B. Resistor 340 may be about 22.5 inches in length. Each lower section 328 of the clips 320 has a hole 346 with a diameter larger than the outer diameter of resistor 340. Due to the angled structure of clips 320, each of the holes 346 within lower sections 328 of the clips can be aligned to enable insertion of resistor 340 between the three clips. Particularly, the inner end 342 may be inserted into hole 346 within lower section 328 of inner conductive clip 320A, and the outer end 344 may be inserted into hole 346 within lower section 328 of outer conductive clip 320B. After insertion, the resistor 340 is thereby frictionally held in place along rear face 208 of support plate 204 within power rail retention system 300.

For additional structural support, a central portion of resistor 340 may pass through a hole 346 within lower section 328 of insulative clip 320C, as shown in FIG. 3B. As clip 320C is not conductive, its connection to resistor 340 does not contribute to the electrical circuit otherwise formed between inner power rail 108A and outer power rail 108B. Additional structure may be employed to facilitate physical and electrical attachment of resistor 340 to inner conductive clip 320A and outer conductive clip 320B as appropriate and will be apparent to those of skill in the field from this disclosure.

In addition to generating heat, resistor 340 also may serve as a ballast load for a substation providing the electrical energy on power rails 108. The voltage and current conducted on power rails 108 often will be supplied from a substation (not shown) that converts medium voltage AC electrical power received from a distribution line to lower voltage DC electrical power. In some examples, silicon-controlled rectifiers (SCRs) in the substation help provide the AC-DC conversion. The firing angle for the SCRs can be varied based on the load on power rails 108, and a condition with very low or no load on power rails 108 can require very small firing angles and lead to low stability for the SCRs. The low stability can cause the substation to generate irregular output voltages at low loads. Resistor 340 across inner power rail 108A and outer power rail 108B at multiple locations along the rails can provide a parasitic load or ballast for the SCRs and help the substation maintain a stable output voltage when no other load exists on the rails. When applied across multiple support structures along a haul route, resistors 340 may provide several kilowatts of parasitic load. Placing this load in power rail retention system 300 helps avoid adding the ballast within the substation, which may be restricted by space and thermal constraints.

Moving from FIGS. 3A and 3B, FIG. 4 illustrates one structure of inner conductive clip 320A that facilitates holding resistor 340 and completing an electrical circuit consistent with the principles of the present disclosure. In this example, inner conductive clip 320A is formed with a core or frame of insulative material, such as pultruded FRP, and includes a front 402 with an upper front 406 and a lower front 408 and a rear 404 with an upper rear 410 and a lower rear 412. When installed, the front 402 faces away from inner power rail 108A, while the rear 404 faces toward inner power rail 108A.

Referring first to rear 404 on the right side of FIG. 4, inner conductive clip 320A includes a rail shim 414 of conductive material. In some options, rail shim 414 is a pliable metal sheet, such as stainless steel, aluminum, or a similar material, shaped to cover at least a portion of upper rear 410. In the example of FIG. 4, rail shim 414 is angled to match the angular shape of rear 404 between upper rear 410 and lower rear 412. A first rivet 416 attaches rail shim 414 to lower rear 412. When inner conductive clip 320A is installed in power rail retention system 300 as shown in FIGS. 3A and 3B, rail shim 414 will press against power rails 108 with resiliency, forming a secure electrical connection and conductive path with the rail. That conductive path will continue on rear 404 from first rivet 416 through a first conductor 420, through a light source 422 (discussed in more detail below), and to a second rivet 426. The second rivet 426 provides an electrical path to front 402 through its second rivet pin 428. It will be appreciated that this arrangement is exemplary only and that other structures for providing a conductive path along upper rear 410 and lower rear 412 from rear 404 to front 402 may be employed without departing from the scope of the present disclosure.

Referring to front 402 on the left side of FIG. 4, tabbed shim 430 covers at least part of lower front 408. In some examples, tabbed shim 430 is also a pliable metal sheet, such as aluminum, steel, or a similar material. The tabbed shim 430 provides a conductive path from second rivet pin 428 to tabs 432 surrounding hole 346. As shown in FIG. 4, tabs 432 are segments of tabbed shim 430 generally extending into and around hole 346. The segmented nature of tabs 432 and their position within hole 346 enables the tabs to physically receive and electrically contact resistor 340 within inner conductive clip 320A. In some examples, tabs 432 will have sufficient flexibility to enable resistor 340 to be readily inserted in hole 346 while providing a resilient force against inner end 342 to hold the resistor in place. Consequently, tabbed shim 430 contributes to providing conductivity to inner conductive clip 320A and completes an electrical path from inner power rail 108A to resistor 340.

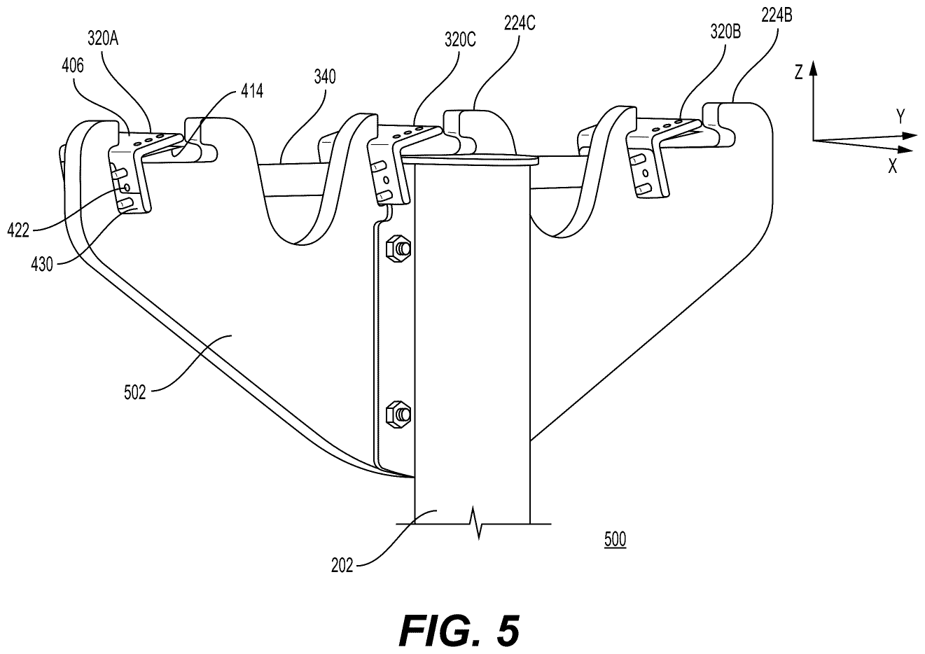

As illustrated, first rivet 416 and second rivet 426 pass through lower section 328 of inner conductive clip 320A as first rivet pin 418 and second rivet pin 428, respectively. While second rivet pin 428 provides a conductive path between rail shim 414 and tabbed shim 430, both first rivet pin 418 and second rivet pin 428 may be configured to extend past the surface of lower front 408. In some examples, the length of first rivet pin 418 and second rivet pin 428 is a few centimeters past the surface of lower front 408, although the precise distance may vary based on the implementation. As illustrated in FIG. 3B and FIG. 5, clips 320 may be installed in grooves 228 such that hole 346 is positioned adjacent a rear face 208 of support plate 204 and light source 422 is positioned adjacent a front face 502 of the support plate. By extending past the surface of lower front 408, first rivet pin 418 and second rivet pin 428 in inner conductive clip 320A may function as stops to prevent excess movement of inner conductive clip 320A laterally with respect to support plate 204, i.e., along the −X axis in FIGS. 3B and 5. After resistor 340 is installed in holes 346, the resistor and the rivet pins will effectively lock inner conductive clip 320A in place within grooves 228. Similar configurations may be adopted for outer conductive clip 320B and insulative clip 320C, as shown in FIG. 5.

As mentioned above, the conductive path through inner conductive clip 320A may include light source 422. When inner power rail 108A and outer power rail 108B are energized and sufficient current is flowing through resistor 340 (e.g., 40 mA), light source 422 will be energized and illuminated on front 402. In some examples, light source 422 is a light emitting diode (LED), although other types of light sources or other forms of sensory indication, such as audible indicators, are within the scope of the present disclosure. In one example, the frame of a conductive clip may be constructed from polycarbonate material rather than FRP, which may enable the entire clip structure to become illuminated rather than a discrete LED.

Activation of light source 422 can provide useful information to operators of work machine 100 and power rail retention system 300. For instance, illumination of the LED indicates that power rails 108 are energized with electricity, as activation of the LED occurs when current flows from inner conductive clip 320A and through resistor 340. Therefore, an operator or bystander near support pole 202 can refer to the light source to verify the energized state of the system as a safety check. The use of light sources atop multiple support poles 202 along a haul route provides redundancy to this safety verification. Positioned on inner conductive clip 320A on multiple stanchions along a haul route, light source 422 can also provide guidance to a driver of work machine 100 to indicate the location of power rails 108 in situations of poor visibility. The driver could refer to the light sources to aid in maintaining proper alignment between contactor 118 and power rails 108.

Accordingly, inner conductive clip 320A with light source 422 may be installed on an end of the clip closest to haul route 101 and with light source 422 positioned adjacent a front face 502 of the support plate that is visible by an operator on an approaching work machine. For instance, FIG. 5 illustrates a bracket assembly 500 without rails with inner conductive clip 320A positioned at the left end and adjacent front face 502 so that light source 422 will be visible to a work machine approaching front face 502 to the left of bracket assembly 500. Having a light source 422 on multiple ones of the bracket assembly 500 may generate a lighted path corresponding to the conductor rails along a haul route 101. The outer conductive clip 320B does not include an LED in FIG. 5, although additional light sources could be included within outer conductive clip 320B or other components of bracket assembly 500, as desired.

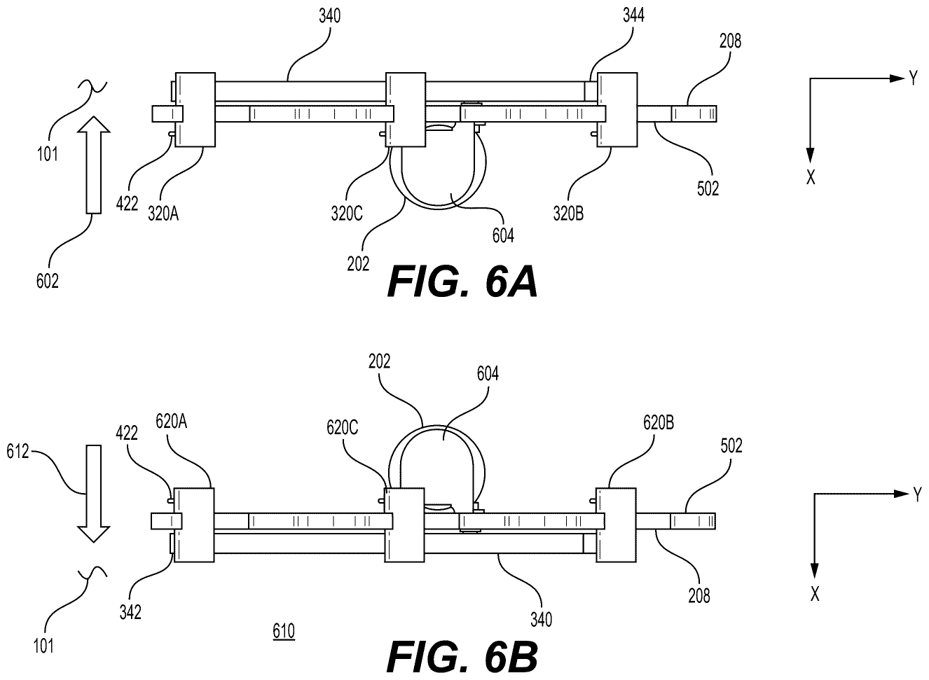

In some examples consistent with this disclosure, the positioning of inner conductive clip 320A and orientation of bracket assembly 500 may vary based on the direction of travel of work machine 100. The example of FIG. 5 illustrates an orientation of bracket assembly 500 for a work machine having its conductor rod and contactor 118 extending from a right side of the machine (i.e., a “right-handed machine”), such that the vehicle approaches front face 502 and light source 422 is visible to the operator. A different arrangement may be used for guiding a work machine having its conductor rod and contactor 118 extending from a left side of the machine (i.e., a left-handed machine”), such as with work machine 100 in FIG. 1. FIGS. 6A and 6B illustrate examples of these differences.

FIG. 6A is a top view 600 of bracket assembly 500 that may be employed to power a right-handed machine in a first direction of travel 602 along haul route 101. The front 402 is attached near top end 604 of support pole 202. The conductive clips are arranged for this orientation with inner conductive clip 320A next to haul route 101 and outer conductive clip 320B at the opposite end of bracket assembly 500. As the right-handed machine drives in the first direction of travel 602 (in the −X direction), it approaches front face 502, and light source 422 is visible on inner conductive clip 320A.

Conversely, FIG. 6B is a top view 610 of a bracket assembly that may be used to power a left-handed machine, such as work machine 100 in FIG. 1, in a second direction of travel 612 along haul route 101. In this configuration, the conductive clips are arranged with inner conductive clip 620A next to haul route 101 and outer conductive clip 620B at the opposite end of the bracket assembly. As the left-handed machine drives in the second direction of travel 612 (in the X direction), it approaches front face 502, and light source 422 is visible on inner conductive clip 620A. To accommodate this difference in machine handedness, clips 620 for a left-handed machine are generally mirror opposites from clips 320 for a right-handed machine, as shown in FIGS. 6A and 6B and discussed below.

FIGS. 7A and 7B provide a comparison of clips 320 for a right-handed machine and clips 620 for a left-handed machine. In FIG. 7A, clips 320 are arranged within bracket assembly 500 with inner conductive clip 320A closest to the haul route. To ensure that light source 422 faces an approaching right-handed machine traveling in first direction of travel 602, the LED is positioned on the right side of inner conductive clip 320A, and hole 346 is positioned on the left side. The outer conductive clip 320B locks outer power rail 108B in place at the opposite end of the bracket, and insulative clip 320C locks middle power rail 108C in place in the center. FIG. 7A further illustrates a configuration for tabbed shim 430 in outer conductive clip 320B in which an LED is not present. As a result, tabbed shim 430 in outer conductive clip 320B may cover most of the lower front 408, as compared with inner conductive clip 320A. As also shown, both tabbed shim 430 and rail shim 414 may be omitted from insulative clip 320C to protect against any electrical shorting from middle power rail 108C to resistor 340 within hole 346.

In FIG. 7B, clips 620 are arranged similarly to clips 320 in FIG. 7A with inner conductive clip 620A being closest to the haul route. However, to ensure that light source 422 faces an approaching left-handed machine traveling in second direction of travel 612, inner conductive clip 620A has a mirrored orientation to inner conductive clip 320A with light source 422 being on the left side and hole 346 being on the right side. The outer conductive clip 620B is located at the opposite end of the bracket for FIG. 7B, and insulative clip 620C without shims is located in the middle.

FIG. 7B further depicts an option for minimizing a number of parts for the clips. As shown, clips 620 may have the same configuration of openings or holes within upper section 326 and lower section 328. As a result, at least the base or frame for each clip could be a single part, rotatable to serve as either one of clips 320 or one of clips 620. The addition of an appropriate rail shim 414, tabbed shim 430, first conductor 420, light source 422, or light source 422 could transform the base for the clip into one of the six clips shown in FIGS. 7A and 7B. Other approaches to minimizing a parts count or forming one of the conductive or insulative clips will be known to those skilled in the field based on the present disclosure.

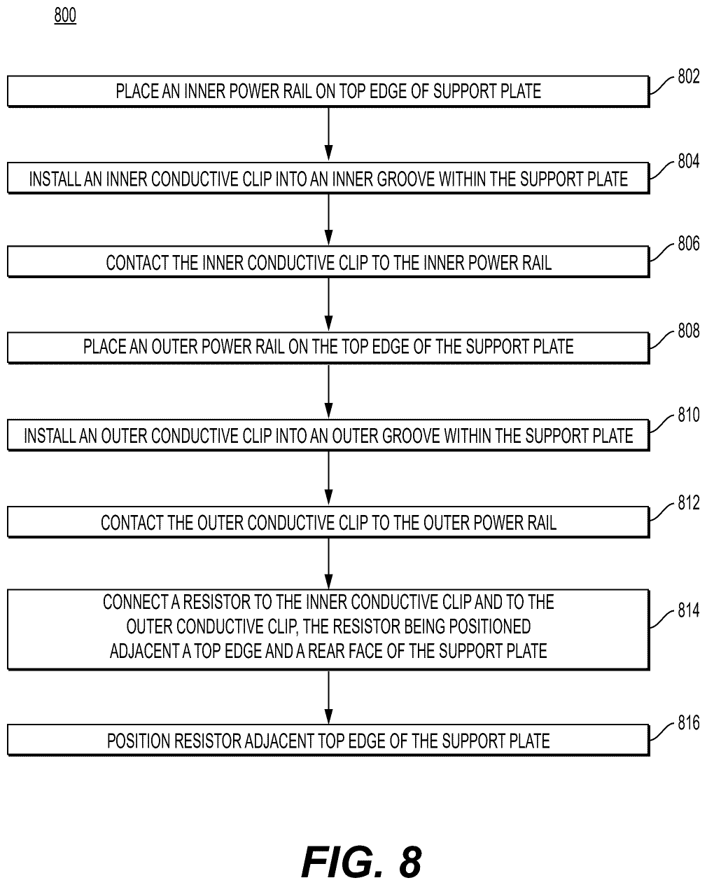

Turning from the structure and operation of power rail retention system 300 as illustrated in FIG. 2 through FIG. 7B to a method involving this system, FIG. 8 is a flowchart of a representative method for assembling a power rail retention system. The example method 800 is illustrated as a collection of steps in a logical flow diagram, which represents operations that can be performed in assembling a power rail retention system. The order in which the operations are described is not intended to be construed as a limitation, and any number of the described steps can be combined and performed in any order, in parallel, or simultaneously to implement the process.

Generally embodied as 800 in FIG. 8, the method begins with step 802 of placing an inner power rail on a support plate. As explained above with respect to FIGS. 3A and 3B, an inner power rail 108A is placed with its flanged bottom 316 on an inner rail support 220A of support plate 204. The support plate may be held by a support pole 202 at a heightened position above the ground, and inner rail support 220A may be a substantially horizontal surface within a top edge 210 of the support plate. A first side of flanged bottom 316 may be positioned to be under a tooth 224A along a top edge 210 of the support plate.

In a second step 804, a lower section of an inner conductive clip is installed into an inner groove within the support plate. As illustrated in FIGS. 3A and 4, for example, the lower section of the inner conductive clip is angled with respect to an upper section of the inner conductive clip. Additionally, support plate 204 includes an inner groove 228A extending from inner rail support 220A, and the lower section of the inner conductive clip is sized to fit frictionally within inner groove 228A.

In a step 806, the upper section of the inner conductive clip is placed into contact with the inner power rail. Although addressed here as a separate step 806 for clarity, steps 804 and 806 may in practice occur at the same time during installation. The upper section is typically angled from the lower section and may be sized to provide resilient pressure against a second side of flanged bottom 316 for inner power rail 108A. The contacting of the inner conductive clip with the inner power rail can help retain the rail in place and provide electrical conductivity between the components.

Steps 808, 810, and 812 repeat steps 802, 804, and 806 for an outer power rail. Specifically, step 808 involves placing an outer power rail on an outer rail portion on the top edge of the support plate; step 810 entails installing a lower section of an outer conductive clip into an outer groove within the support plate; and step 812 involves contacting the upper section of the outer conductive clip to the outer power rail. Similar to the process for inner power rail 108A, these steps for an outer power rail 108B, as shown in FIGS. 3A and 3B, lead to a frictional locking of the outer power rail onto support plate 204. Steps 810 and 812 may take place at essentially the same time.

Method 800 continues with step 814, connecting an inner end of a resistor to the lower section of the inner conductive clip and an outer end of the resistor to the lower section of the outer conductive clip. FIG. 3B illustrates the installation of resistor 340 into holes 346 within the lower sections 326 of inner conductive clip 320A and of outer conductive clip 320B. More particularly, tabs 432 within tabbed shim 430 in the inner conductive clip 320A and in the outer conductive clip 320B may provide a frictional and conductive connection between the clips and resistor 340. In a final step 816, typically occurring simultaneously with step 814, the resistor is positioned adjacent a top edge of the support plate. As explained in more depth above, the alignment of holes 346 within clips 320 may place resistor 340 along top edge 210 and across at least first concavity 230A along a front face of the support plate 204. Accordingly, when the power rails are energized, electrical current will flow through resistor 340, which will radiate heat to help melt snow or ice and evaporate moisture. Additional uses of the current flowing through the resistor may include providing a ballast for a substation powering the rails and powering a light source to provide a safety indication along the rails, as discussed above.

Those of ordinary skill in the field will appreciate that the principles of this disclosure are not limited to the specific examples discussed or illustrated in the figures. For example, while the power rail retention system has been discussed in the context of a resistor positioned between conductive clips of an inner and outer rail in a three-rail system, other arrangements are feasible. The concepts are applicable to systems having different numbers of rails as well, such as only two rails. Moreover, in a three-rail system, the resistor could alternatively be installed between one of the outside rails and the middle rail. In addition, the principles disclosed are not limited to implementation on work machines. In addition, the options provided for left-handed machines and right-handed machines are not required, and the clips may be standardized for bidirectional traffic on a haul route.

### INDUSTRIAL APPLICABILITY

The present disclosure provides a heated bracket assembly for supporting power rails for an electrically powered machine and methods for assembling the bracket assembly. A power rail retention system includes the heated bracket assembly and supports rails carrying different voltages supplied by a substation. A support plate contains grooves configured to accept lower sections of angled clips, where upper sections of the clips frictionally hold the power rails against the support plate. A resistor is coupled between the lower sections of at least two conductive clips and proximate a top edge of the support plate between adjacent rails. When the rails are energized, current flows through the resistor, which may generate ambient heat to evaporate moisture on the support plate, power a light source on the bracket, and provide a ballast load for the substation.

As noted above with respect to FIGS. 1-8, a power rail retention system such as 300 in FIGS. 3A and 3B may include a support pole and a bracket assembly attached to a top end of the support pole for holding power rails 108. A support plate 204 within bracket assembly 500 includes an inner rail portion 220A configured to support an inner power rail 108A and an outer rail portion 220B configured to support an outer power rail 108B. A resistor 340 is electrically coupled to the inner power rail and to the outer power rail and positioned adjacent a top edge 210 of support plate 204. An inner conductive clip 320A and an outer conductive clip 320B may help resiliently retain the inner power rail 108A and the outer power rail 108B, respectively, on the support plate. As well, the clips may include holes to receive ends of resistor 340, completing an electrical circuit between inner power rail 108A and outer power rail 108B.

In the examples of the present disclosure, a power rail retention system with a heated bracket assembly provides radiant heat in the vicinity of dielectric material between power rails, helping to evaporate moisture along a creepage distance and avoid a decrease in dielectric resistance. Accordingly, current leakage at each stanchion of the power rails can be minimized, avoiding voltage and power loss for work machines powered by the rails. Additionally, resistors at multiple support plates along a route can provide parasitic load as a ballast to help stabilize voltages from a substation when no load is otherwise on the rails.

Inner conductive clip 320A and outer conductive clip 320B help lock inner and outer rails in place while securing the resistor proximate to a top edge of the plate. Shims on the clips provide resilient force against the rails, tabs to grasp the resistor, and a conductive path between the inner power rail 108A to outer power rail 108B. Rivets that hold the shims in place can provide both a conductive path and mechanical stops to limit lateral movement of the clips within the support plate. Finally, a light source within the clips provides a safety verification to personnel that the rails are energized, which can help an operator guide a vehicle along the rails during poor visibility.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Terms of approximation are meant to include ranges of values that do not change the function or result of the disclosed structure or process. For instance, the term “about” generally refers to a range of numeric values that one of skill in the art would consider equivalent to the recited numeric value or having the same function or result. Similarly, the antecedent “substantially” means largely, but not wholly, the same form, manner or degree, and the particular element will have a range of configurations as a person of ordinary skill in the art would consider as having the same function or result.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A bracket assembly for retaining power rails, comprising:
an insulative base having at least a top surface, the top surface including:
a first rail support portion configured to receive a first of the power rails,
a second rail support portion configured to receive a second of the power rails,
a first conductive clip proximate the first rail support portion;
a second conductive clip proximate the second rail support portion; and
a resistor electrically connected to the first conductive clip and the second conductive clip, the resistor being positioned proximate to the top surface of the insulative base and configured to emit heat to the top surface when current from the power rails passes through the resistor.

2. The bracket assembly of claim 1, further comprising a first groove extending into the insulative base and securing the first conductive clip proximate the first rail support portion, and a second groove extending into the insulative base and securing the second conductive clip proximate the second rail support portion.

3. The bracket assembly of claim 1, wherein the top surface of the insulative base further comprises a first concavity between the first rail support portion and the second rail support portion, wherein the resistor is positioned across the first concavity.

4. The bracket assembly of claim 1, wherein the resistor has an inner end and an outer end, the inner end being retained within the first conductive clip, the outer end being retained within the second conductive clip.

5. The bracket assembly of claim 3, further comprising:
a third rail support portion configured to receive a third of the power rails on the top surface of the insulative base, the third rail support portion being between the first rail support portion and the second rail support portion; and
an insulative clip proximate the third rail support portion.

6. The bracket assembly of claim 5, wherein the top surface of the insulative base further comprises a second concavity, wherein the first concavity is between the first rail support portion and the third rail support portion and the second concavity is between the second rail support portion and the third rail support portion, wherein the resistor is positioned across the first concavity and the second concavity.

7. The bracket assembly of claim 1, wherein the first conductive clip and the second conductive clip respectively comprise an upper section angled with respect to a lower section, wherein the upper section is configured to contact and retain one of the power rails against the insulative base.

8. The bracket assembly of claim 7, wherein the lower section is secured within a respective one of a first groove and a second groove extending into the insulative base, the lower section being perpendicular to a front surface of the insulative base.

9. The bracket assembly of claim 8, further comprising a hole within the lower section, the hole configured to receive an end of the resistor.

10. The bracket assembly of claim 9, further comprising conductive tabs within the lower section, the conductive tabs extending radially into the hole and configured to contact the end of the resistor.

11. The bracket assembly of claim 1, wherein the first conductive clip contains a light source electrically connected to the resistor and configured to illuminate when current passes through the resistor.

12. A power rail retention system, comprising:
an inner power rail having a first flanged bottom;
an outer power rail having a second flanged bottom;
a support pole having a top end and a bottom end; and
a bracket assembly attached adjacent to the top end of the support pole, the bracket assembly comprising:
a support plate having at least a top edge, the top edge including:
an inner rail portion configured to support the inner power rail,
an outer rail portion configured to support the outer power rail, and
a resistor electrically coupled to the inner power rail and the outer power rail, the resistor being positioned adjacent the top edge of the support plate.

13. The power rail retention system of claim 12, wherein the top edge of the support plate further comprises a first concavity between the inner rail portion and the outer rail portion, wherein the resistor is positioned across the first concavity.

14. The power rail retention system of claim 12, wherein the bracket assembly further comprises:
an inner conductive clip holding the first flanged bottom to the inner rail portion; and
an outer conductive clip holding the second flanged bottom to the outer rail portion, the resistor being connected to the inner conductive clip and the outer conductive clip.

15. The power rail retention system of claim 14, wherein the inner conductive clip contains a light source electrically connected to the resistor and configured to illuminate when current passes through the resistor.

16. The power rail retention system of claim 14, further comprising an inner groove and an outer groove within the support plate, the inner groove securing the inner conductive clip into the support plate, the outer groove securing the outer conductive clip into the support plate.

17. The power rail retention system of claim 15, wherein the inner conductive clip and the outer conductive clip each comprises an insulative frame with an exterior and a conductive shim surrounding sections of the exterior.

18. A method, comprising:
placing an inner power rail on an inner rail portion on a top edge of a support plate;
installing a lower section of an inner conductive clip into an inner groove within the support plate;
contacting an upper section of the inner conductive clip to the inner power rail;
placing an outer power rail on an outer rail portion on the top edge of the support plate;
installing a lower section of an outer conductive clip into an outer groove within the support plate;
contacting an upper section of the outer conductive clip to the outer power rail;
connecting an inner end of a resistor to the lower section of the inner conductive clip and an outer end of the resistor to the lower section of the outer conductive clip; and
positioning the resistor adjacent a top edge of the support plate.

19. The method of claim 18, wherein the lower section of the inner conductive clip contains a light source in electrical contact with the inner power rail and the resistor, and wherein installing the lower section of the inner conductive clip into the inner groove of the support plate comprises orienting the inner conductive clip so the light source is adjacent a side of the support plate opposite from the resistor.

20. The method of claim 18, wherein the lower section of the inner conductive clip contains a light source in electrical contact with the inner power rail and the resistor, the method further comprising:
applying DC voltage of a first polarity to the inner power rail;
applying DC voltage of a second polarity to the outer power rail; and
confirming illumination of the light source.
